(19) United States
(12) Patent Application Publication
(10) Pub. No.: US 2016/0364752 A1
(43) Pub. Date: Dec. 15, 2016

(54) System and Method for Providing Customized Advertising for Podcasts

(71) Applicant: Bondi Waves, Inc., Los Angeles, CA (US)

(72) Inventor: Osher Gunsberg, Bronte (AU)

(73) Assignee: Bondi Waves, Inc.

(21) Appl. No.: 14/734,837

(22) Filed: Jun. 9, 2015

(51) Int. Cl. G06Q 30/02; G06Q 50/00; H04L 29/08

(52) U.S. Cl. CPC G06Q 30/0255; H04L 67/306; G06Q 30/0267; G06Q 50/01

(57) ABSTRACT

The embodiments disclosed herein provide a mechanism for obtaining a plurality of advertisements and program content from an announcer, to store associated metadata with each advertisement, to obtain user profile information, and to provide program content and a selected advertisement from the plurality of advertisements to a client.

### TECHNICAL FIELD

An improved advertising generation and provisioning system for podcasts is disclosed.

### BACKGROUND OF THE INVENTION

Podcasts are well-known in the prior art. A podcast generally comprises a program, typically of audio content, made available in digital format to a client device for automatic download or streaming over the Internet. A podcast sometimes comprises an episodic series of files subscribed to and downloaded by the client device.

The content of a podcast often comprises audio content created by one or more announcers. For example, “talk radio” programs often involve an announcer who provides his or her commentary, analysis, opinions, etc. to his or her listeners. Such programs traditionally were provided over broadcast radio but today often are provided by podcast.

Providing advertising during a podcast also is known in the prior art. FIG. 1 shows prior art podcast system 100. Content engine 110 provides content 140 (such as a recorded talk radio show) to advertising engine 120, which in turn appends advertisement 150 to content 140, which together are provided to client 130 as a podcast.

In prior art podcast system 100, the content provider sometimes provides advertisement 150 that contains the same announcer's voice as in content 140. This is similar to the situation where a talk radio announcer records an audio advertisement for a product and plays that advertisement during his or her radio show. This can be a very powerful advertising method, as the listeners often are heavily influenced by the announcer.

However, what is lacking in the prior art is the ability to obtain a plurality of advertisements and program content from an announcer, to receive profile data about a particular user from a plurality of sources, to select one of the plurality of advertisements that is best suited for the user based on the profile data, and to provide the selected advertisement with the program content to the user through a podcast.

### SUMMARY OF THE INVENTION

The embodiments disclosed herein provide a mechanism for obtaining a plurality of advertisements and program content from an announcer, to store associated metadata with each advertisement, to obtain user profile information, and to provide program content and a selected advertisement from the plurality of advertisements to a client.

### BRIEF DESCRIPTION OF THE DRAWINGS

FIG. 1 depicts a prior art podcast system.

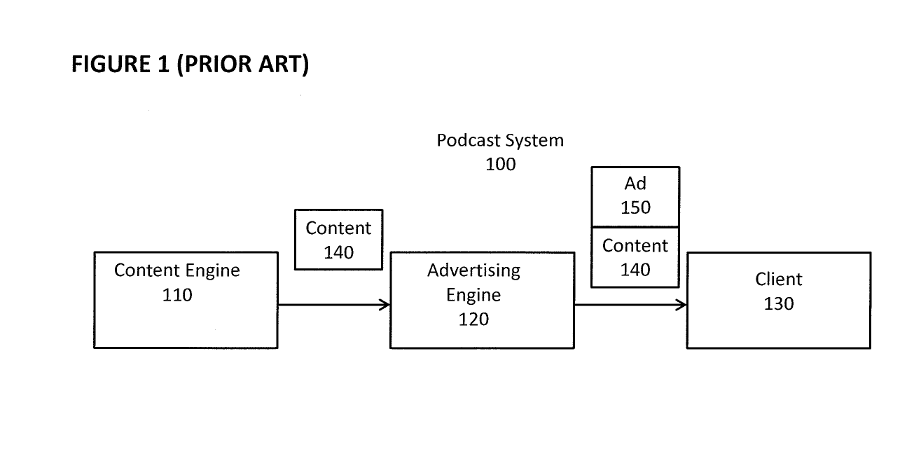

FIG. 2 depicts a first embodiment of a digital content and customized advertising system.

FIG. 3 depicts a second embodiment of a digital content and customized advertising system.

FIG. 4 depicts a system for generating and storing program content and a plurality of advertisements and related metadata.

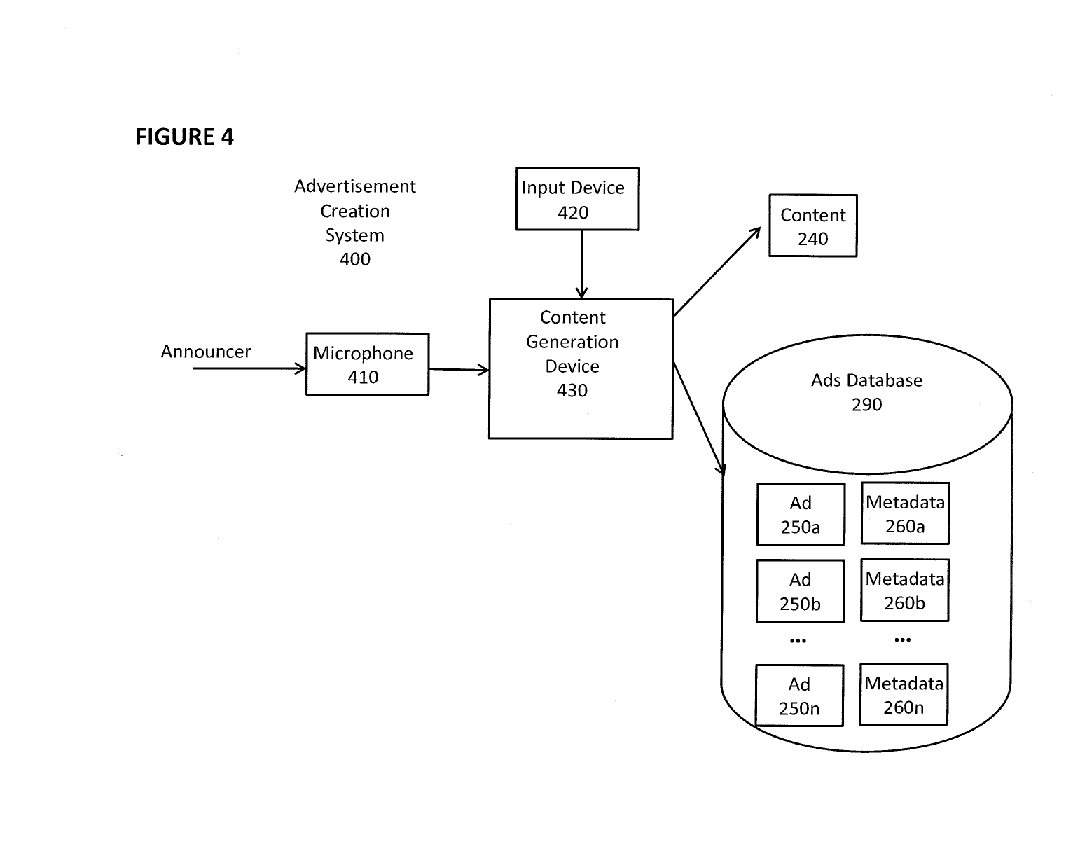

FIG. 5 depicts a system for compiling user profile information from a plurality of sources.

### DETAILED DESCRIPTION OF THE PREFERRED EMBODIMENTS

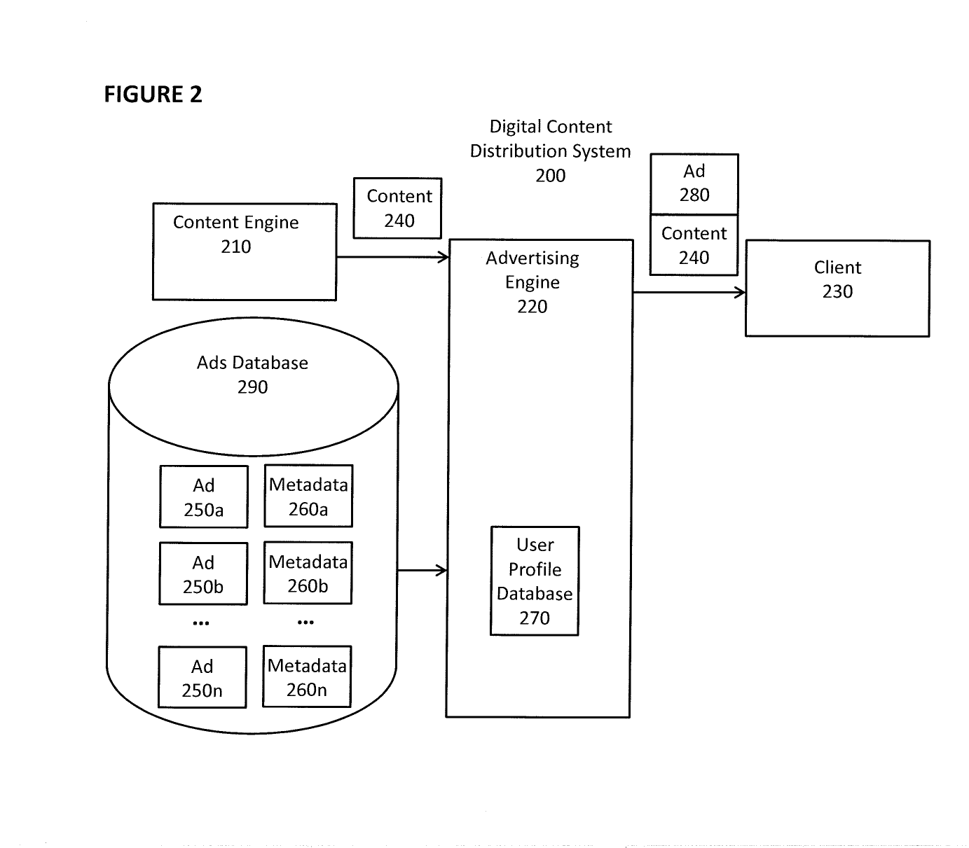

FIG. 2 depicts digital content distribution system 200. Digital content distribution system 200 comprises content engine 210, advertising engine 220, client 230, user profile database 270, and advertising database 290. In the preferred embodiment, digital content distribution system 200 is a podcast system, but it is to be understood that other mechanisms of distributing digital content (such as streaming of radio content) can be used as well.

Advertising database 290 contains a plurality of advertisements and associated metadata, including exemplary advertisements 250a, 250b, . . . , 250n and associated metadata 260a, 260b, . . . 260n (where n is an integer). Based on data in user profile database 270 regarding the user of client 230 and the metadata 260a, 260b, . . . 260n, advertising engine 220 selects the most appropriate advertisement for the user. The selected advertisement 280 is appended to content 240 provided by content engine 210 and provided to client 230 as digital content, such as a podcast. Thus, advertisement 280 is customized for the user of client 230.

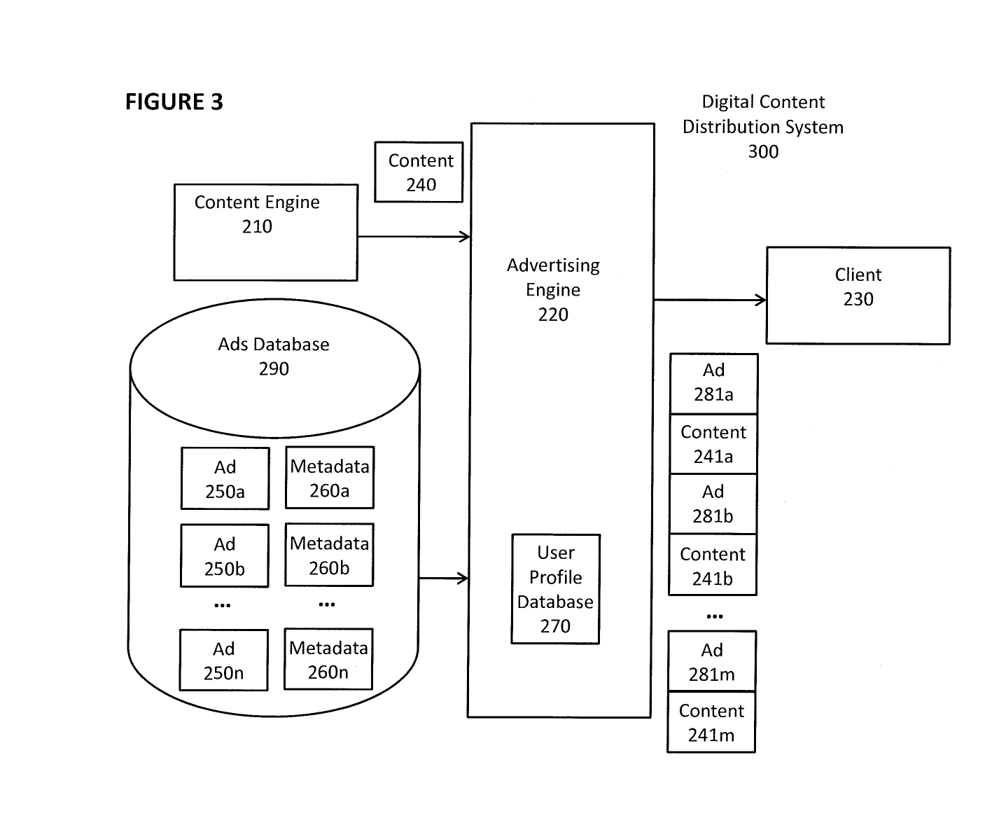

FIG. 3. depicts digital content distribution system system 300. In the preferred embodiment, digital content distribution system 300 is a podcast system, but it is to be understood that other mechanisms of distributing digital content (such as streaming of radio content) can be used as well. Digital content distribution system 300 is similar to digital content distribution system 200, except that content 240 is separated into clips 241a, 241b, . . . , 241m and advertisements 281a, 281b, . . . , 281m are provided to client 230 along with clips 241a, 241b, . . . , 241m (where m is an integer). That is, instead of providing one advertisement and one content piece to client 230, a plurality of advertisement and a plurality of pieces of content are provided to client.

Figure depicts advertisement creation system 400. Advertising creation system 400 comprises microphone 410, which receives audio from the Announcer, input device 420 (such as a keyboard, mouse, touchscreen, or network interface). content generation device 430, and advertisement database 290. The Announcer creates content 240 (such as a talk radio program) as well as a plurality of advertisements, such as advertisements 250a, 250b, . . . 250n. Input device 420 is used to generate metadata for each advertisement, such as metadata 2601, 260b, . . . 260n.

Examples of metadata include: advertised product name; sales price of advertised product; demographic information of target audience, such as age, gender, location of residence, amount of formal education, occupation, income range, number of children, marital status; target audience age range, target audience geography; and other information specific to the advertised product, target audience, or other factors.

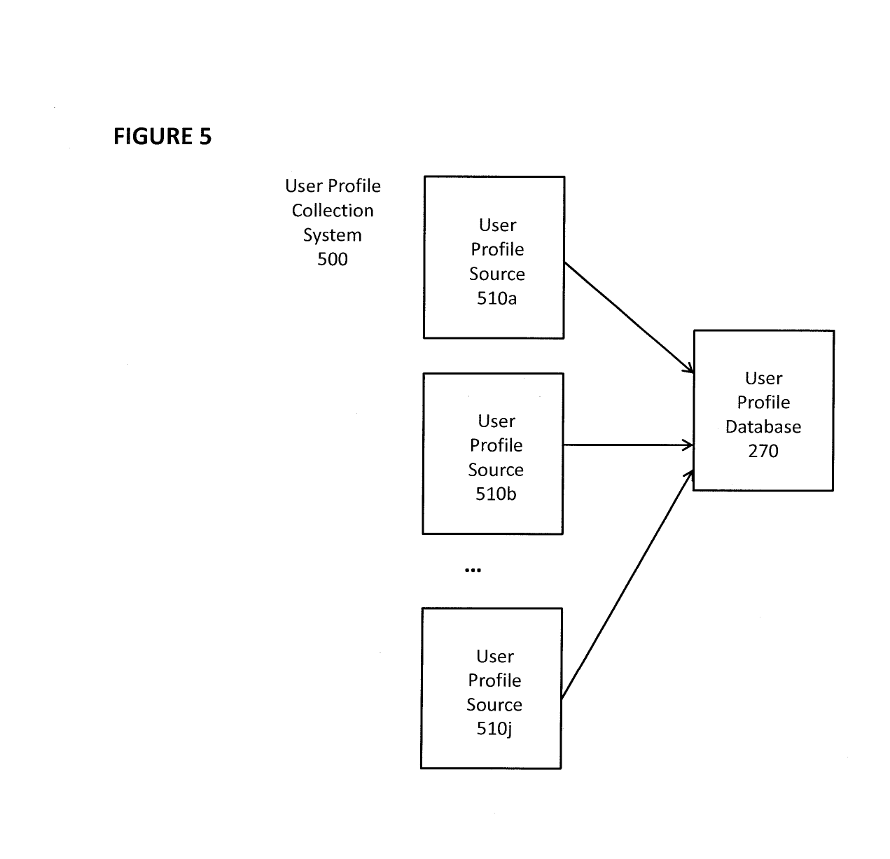

FIG. 5. depicts user profile collection system 500. User profile collection system 500 comprises user profile database 270 and a plurality of user profile sources, such as exemplary user profile sources 510a, 510b, . . . , 510j (where j is an integer). Examples of user profile sources include websites, web servers, input devices, data collected from applications, social networks, and other sources. For example, user profile source 510a might include data gathered from facebook regarding the user of client 230, such as age and gender of user. Using that information, advertising engine 220 can select the most appropriate advertisement for a person of that age and gender. One or more of user profile sources 510a, 510b, . . . , 510j also can be client 230 itself. For example, client 230 can provide the following types of data to user profile database 270: type of listening device (e.g., smart phone, tablet, car, etc.); model of listening device (e.g., iPhone 5, iPhone 6, etc.); type of application used for listening; other shows or podcasts that are listened to using that application; online purchase history; time spent listening to podcasts or other digital content; if a particular advertisement has been skipped or fast forwarded over; how many times a user has actioned or clicked on a previous advertisement. Using that information, advertising engine 220 can select the most appropriate advertisement for the user of client 230 (e.g., an advertisement targeted for users of iPhone 6, or an advertisement targeted for users with a short attention span who will only listen to short advertisements).

Through the embodiments described herein, customized advertising is provided to the user of a client along with program content in digital content such as a podcast.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims.

What is claimed is:

1. A method of generating and distributing digital content and targeted advertising to a client, comprising:
generating, by a content generation device, a piece of digital content and a plurality of advertisements, the piece of digital content comprising an audio recording by a human being and each advertisement comprising a unique audio recording by the human being and each advertisement associated with metadata;
selecting, by an advertising engine, one of the plurality of advertisements based on a user profile and at least some of the metadata;
transferring, to a client, the piece of digital content and the one of the plurality of advertisements.

2. The method of claim 1, wherein the metadata comprises demographic information for a target audience for an advertisement.

3. The method of claim 2, wherein the demographic information comprises age information.

4. The method of claim 2, wherein the demographic information comprises gender information.

5. The method of claim 2, wherein the demographic information comprises information relating to purchasing habits.

6. The method of claim 1, wherein the transferring step comprises sending a podcast to the client.

7. The method of claim 1, wherein the client is a mobile device.

8. The method of claim 1, wherein the user profile comprises information obtained from a social network.

9. The method of claim 1, wherein the user profile comprises information obtained from the client.

10. The method of claim 1, wherein the user profile comprises information obtained from a web server.

11. A system for generating and distributing digital content and targeted advertising, comprising:
a content generation device configured to generate a piece of digital content and a plurality of advertisements, the piece of digital content comprising an audio recording by a human being and each advertisement comprising a unique audio recording by the human being and each advertisement associated with metadata;
an advertising engine configured to select one of the plurality of advertisements based on a user profile and at least some of the metadata;
a client for receiving the piece of digital content and the one of the plurality of advertisements.

12. The system of claim 11, wherein the metadata comprises demographic information for a target audience for an advertisement.

13. The system of claim 12, wherein the demographic information comprises age information.

14. The system of claim 12, wherein the demographic information comprises gender information.

15. The system of claim 12, wherein the demographic information comprises information relating to purchasing habits.

16. The system of claim 11, wherein the transferring step comprises sending a podcast to the client.

17. The system of claim 11, wherein the client is a mobile device.

18. The system of claim 11, wherein the user profile comprises information obtained from a social network.

19. The system of claim 11, wherein the user profile comprises information obtained from the client.

20. The system of claim 11, wherein the user profile comprises information obtained from a web server.
